(19) United States
(12) Patent Application Publication
(10) Pub. No.: US 2024/0062255 A1
(43) Pub. Date: Feb. 22, 2024

(54) System and Related Methods for Tracking and Sharing Service Provider Experiences with Clients

(71) Applicants: CODY MICHAEL DRUMMOND, MORGAN HILL (SC); PIERCE BRENNAN DRUMMOND, SAN JOSE (SC)

(72) Inventors: CODY MICHAEL DRUMMOND, MORGAN HILL (SC); PIERCE BRENNAN DRUMMOND, SAN JOSE (SC)

(21) Appl. No.: 17/891,202

(22) Filed: Aug. 19, 2022

(51) Int. Cl. G06Q 30/02; H04L 9/32

(52) U.S. Cl. CPC G06Q 30/0282; H04L 9/3239

(57) ABSTRACT

The present disclosure provides a system and related methods for tracking and sharing service provider experiences with clients by forwarding client form submissions to a set of one or more servers which create and maintain client profiles in a database. The service providers through which the form submissions are received are then given an opportunity to review their experiences with the client, with all reviews being stored with the associated client profile.

### FIELD OF INVENTION

The present invention relates generally to a systems for sharing working experiences. More specifically, the present invention relates to a system that allows service providers to share experiences with clients and view their reputation.

### BACKGROUND

In the modern day, practically every service provider is rated constantly based on their performance and client experiences, with publicly available review histories that include average ratings and specific comments from previous clients. This provides a high level of transparency and insight for customers looking to procure the services of the provider, and also encourages high quality of service and respectful behaviour from the service providers.

However, there is no equivalent system for service providers to gain insight into client history and behaviour. Clients are equally if not more likely to behave improperly when procuring the services of a service provider—they are liable to be disrespectful, miss payments, expect free services, etc. These issues are particularly prevalent in the contracting industry, where large projects are undertaken that require a lot of commitment from both parties.

Part of the reason such solutions do not exist in the reverse direction is that service providers are less likely to leave poor feedback about a client publicly, since if the client sees that they have done so it could impact their ability to obtain future work, by losing the client to another contractor for example. Clients also generally do not have publicly reviewable profiles to publish such reviews on anyway.

There is a need for a solution which gives service providers more insight into client behaviour without risking the success of their business, and which creates a collaborative environment for sharing useful feedback on clients, helping service providers as a collective.

It is within this context that the present invention is provided.

### SUMMARY

The present disclosure provides a system and related methods for tracking and sharing service provider experiences with clients by forwarding client form submissions to a set of one or more servers which create and maintain client profiles in a database. The service providers through which the form submissions are received are then given an opportunity to review their experiences with the client, with all reviews being stored with the associated client profile.

Thus, according to one aspect of the present disclosure there is provided a system for tracking and sharing service provider experiences with clients, the system comprising: a database having stored thereon data associated with a plurality of service provider profiles and data associated with a plurality of client profiles, the client profile data including identifying data and review and contact histories.

The system further comprises one or more servers in communication with the database, the one or more servers being configured to: receive a client form submission from a first service provider, the form submission including identifying data of the client; check the database to determine if the identifying data matches an existing first client profile; if no match is found, create a first client profile based on the identifying data; if a match is found, provide the first service provider with access to a portion of the review and contact history of the first client profile in the database; after a first predetermined period of time, request a review of the experience first service provider had with the client; receive a review of the experience with the client from the first service provider; and update the first client profile based on the review.

In some embodiments, the identifying data includes one or more of: a phone number, a full name, and a first address line.

In some embodiments, the step of checking the database comprises generating an MD5 hash of the client identifying data received from the first service provider and checking it against a client hash table stored in the database for identical hashes.

In some embodiments, the form submission is automatically forwarded to the system from a first service provider website when the client submits a contact form.

In some embodiments, the one or more servers are further configured to: receive an indication that the first service provider has not yet concluded a work experience with the client;
provide to the first service provider one or more options for selecting a second predetermined period of time; receive a selection from the first service provider; and after the select second predetermined period of time, request a review of the experience the first service provider had with the client.

In some embodiments, communications of client data to the one or more service providers are carried out via e-mail notifications. A service provider's access to the first client profile review and contact history may be tracked using browser cookies

In some embodiments, communications of client data to the one or more service providers are carried out via an online platform.

In some embodiments, if one or more portions of the identifying data are not filled in on the form submission, the one or more servers are configured to not check for or create a client profile.

In some embodiments, the first service provider must go through a registration process and provide access to their contact submission form data in order to access the system.

In some embodiments, the form submission further comprises data indicating the industry and type of services the form submission relates to.

The one or more servers may be further configured to: check the client profile history of contact with other service providers in the selected industry; and check the database to determine each other service provider with a matching industry that the client profile has contacted regarding a similar service; and send a notification to each of those service providers notifying them that the client has contacted the first service provider, the notification comprising a portion of the client profile identifying data.

### BRIEF DESCRIPTION OF THE DRAWINGS

Various embodiments of the invention are disclosed in the following detailed description and accompanying drawings.

FIG. 1 illustrates a flow chart of an example set of operations carried out by one or more servers of the system according to the present disclosure.

FIG. 2 illustrates a first example web page where a service provider inputs their business contact details in order to join and gain access to the system of the present disclosure.

FIG. 3 illustrates a second example web page where a service provider inputs their business industry to assist with tracking in the database.

FIG. 4 illustrates a third example web page where a service provider inputs the services their business provides to assist with tracking in the database.

FIG. 5 illustrates an example notification sent to a service provider regarding a client that has contacted them, the notification comprising review history associated with the client from the database.

FIG. 6 illustrates an example notification sent to the service provider requesting that they review their experience with the client that contacted them or postpone the review for a predetermined period of time.

FIG. 7 illustrates an example review page in which the service provider can relay feedback regarding their experience with the client to be stored and associated with the client profile in the database.

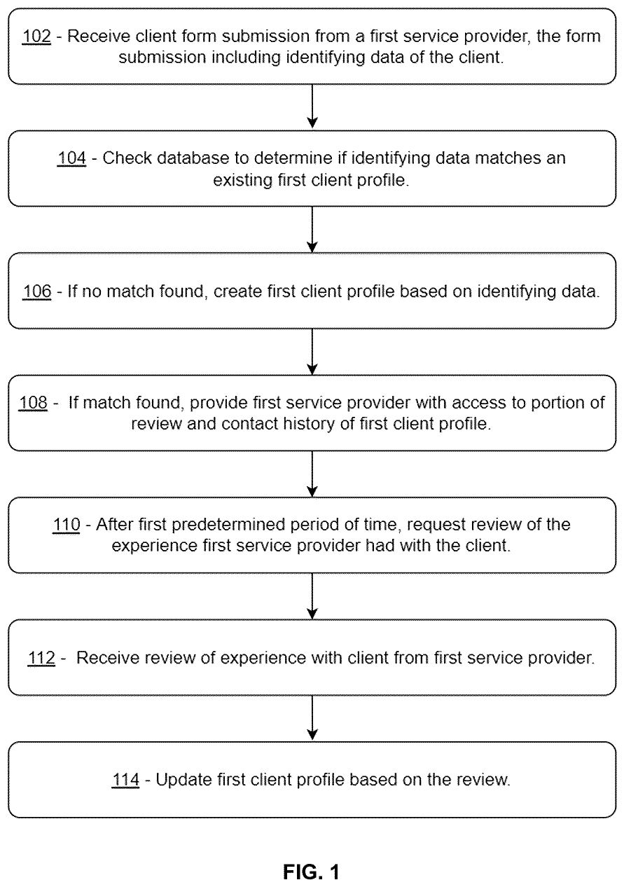

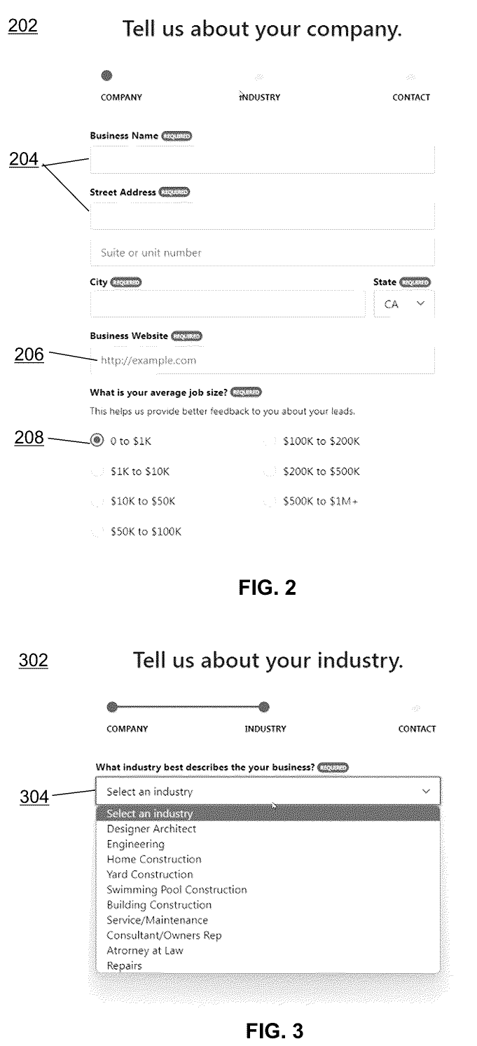

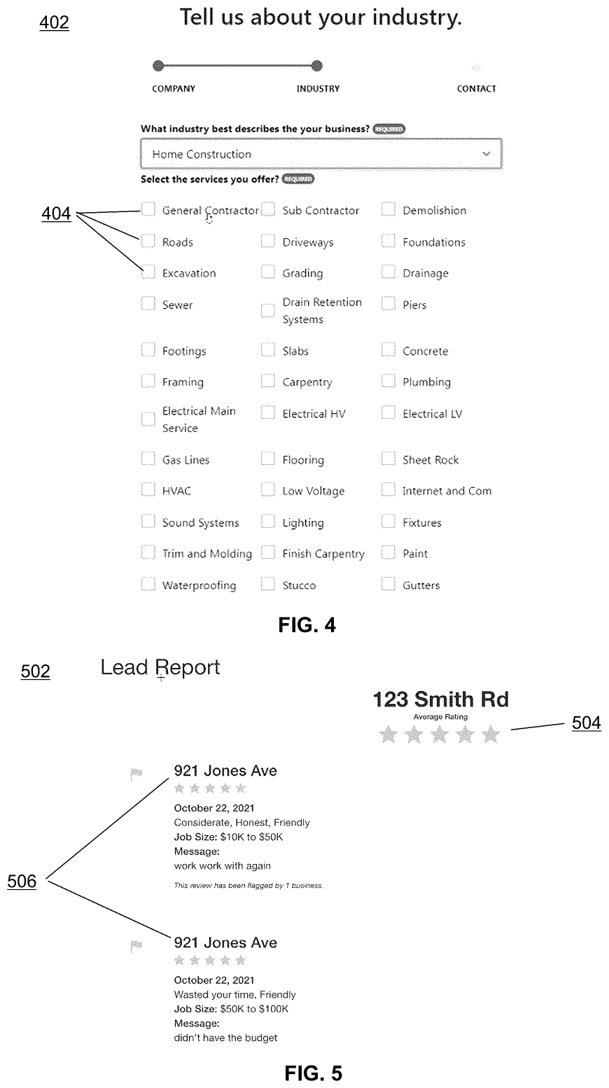

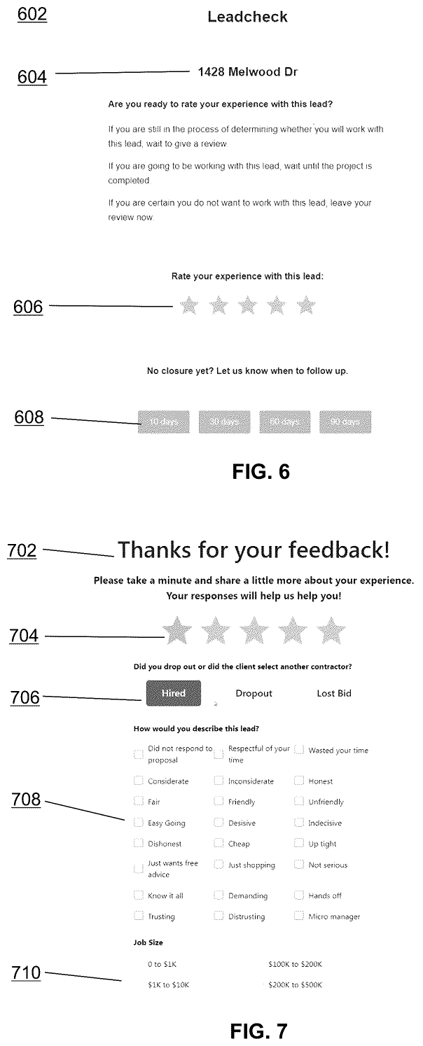

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

One or more of the operations and calculations described herein may be performed by a cloud infrastructure comprising one or more servers and databases. This is merely an example infrastructure however, the servers need not necessarily be cloud-based. The cloud infrastructure may for example comprise a database configured to receive and store multimedia content and user data for a plurality of user accounts and a set of connected servers or nodes configured to enact the operations as disclosed herein.

The cloud infrastructure is configured to communicate with a set of client devices by various means over the network architecture. The client devices include devices configured to communicate with the cloud infrastructure via a communications tower. These devices may include but are not limited to a smartphone, a laptop, and a tablet computer with e-mail and web browser application software.

Any one of the client devices may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes communication tower.

While a specific set of client devices are listed as examples of the architecture, the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

In some examples, each client device may be associated with or “logged in” to a service provider user profile or e-mail address in order to operate within the disclosed system and method, and further configured to send requests, upload user data, and generally interact with the cloud infrastructure via a user interface displayed on the device. Some operations may also be carried out automatically be installing software on certain webpages of the service provider.

In this manner one or more users may access an online platform or web page in order to interact with the system and methods of the present disclosure.

The operations described above for the app may be implemented by one or more servers or computers over a wireless network which the user device are communicating through. Indeed, it should be understood that the operations described herein may be carried out by any suitable processor architecture.

In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for reviewing service provider experiences with clients have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for tracking and sharing service provider experiences with clients, the system comprising:
a database having stored thereon data associated with a plurality of service provider profiles and data associated with a plurality of client profiles, the client profile data including identifying data and review and contact histories; and
one or more servers in communication with the database, the one or more servers being configured to:
receive a client form submission from a first service provider, the form submission including identifying data of the client;
check the database to determine if the identifying data matches an existing first client profile;
if no match is found, create a first client profile based on the identifying data;
if a match is found, provide the first service provider with access to a portion of the review and contact history of the first client profile in the database;
after a first predetermined period of time, request a review of the experience first service provider had with the client;
receive a review of the experience with the client from the first service provider; and
update the first client profile based on the review.

2. A system according to claim 1, wherein the identifying data includes one or more of: a phone number, a full name, and a first address line.

3. A system according to claim 1, wherein the step of checking the database comprises generating an MD5 hash of the client identifying data received from the first service provider and checking it against a client hash table stored in the database for identical hashes.

4. A system according to claim 1, wherein the form submission is automatically forwarded to the system from a first service provider website when the client submits a contact form.

5. A system according to claim 1, wherein the one or more servers are further configured to:
receive an indication that the first service provider has not yet concluded a work experience with the client;
provide to the first service provider one or more options for selecting a second predetermined period of time;
receive a selection from the first service provider; and
after the select second predetermined period of time, request a review of the experience the first service provider had with the client.

6. A system according to claim 1, wherein communications of client data to the one or more service providers are carried out via e-mail notifications.

7. A system according to claim 6, wherein a service provider's access to the first client profile review and contact history is tracked using browser cookies

8. A system according to claim 1, wherein communications of client data to the one or more service providers are carried out via an online platform.

9. A system according to claim 1, wherein if one or more portions of the identifying data are not filled in on the form submission, the one or more servers are configured to not check for or create a client profile.

10. A system according to claim 1, wherein the first service provider must go through a registration process and provide access to their contact submission form data in order to access the system.

11. A system according to claim 1, wherein the form submission further comprises data indicating the industry and type of services the form submission relates to.

12. A system according to claim 11, wherein the one or more servers are further configured to:
check the client profile history of contact with other service providers in the selected industry; and
check the database to determine each other service provider with a matching industry that the client profile has contacted regarding a similar service; and
send a notification to each of those service providers notifying them that the client has contacted the first service provider, the notification comprising a portion of the client profile identifying data.
